(19) United States
(12) Patent Application Publication
(10) Pub. No.: US 2022/0258773 A1
(43) Pub. Date: Aug. 18, 2022

(54) Autonomous Vehicle Rider Authentication, Boarding, And Drop Off Confirmation

(71) Applicant: Ford Global Technologies, LLC, Dearborn, MI (US)

(72) Inventors: Hari Hara Prabhu Narayanan, Royal Oak, MI (US); Karthik Sundar, Dearborn, MI (US)

(73) Assignee: Ford Global Technologies, LLC, Dearborn, MI (US)

(21) Appl. No.: 17/175,776

(22) Filed: Feb. 15, 2021

(51) Int. Cl. B60W 60/00; G06Q 10/06; G06F 21/32; G01C 21/34

(52) U.S. Cl. CPC B60W 60/00253; G06Q 10/06311; B60W 2556/45; G01C 21/3438; G06F 21/32

(57) ABSTRACT

Embodiment of the present disclosure describe systems and methods that assist a booking user to schedule an autonomous vehicle pick up of another user and ensure the identity of the user being picked up by sending a confirmation to the booking user. An autonomous vehicle biometric rider ID system is described that can include Internet of Things (IoT) technology, where the system software may use autonomous vehicle system components such as microphones, cameras and sensors, to send automatic voice/image/text messages to the booking user. The system may allow both the rider(s) and booking user to be connected by in-vehicle or external software available in the vehicle to inform the booking user that the rider has boarded and been transported to the destination.

### BACKGROUND

Autonomous vehicles (AVs) may be used to pick up passengers independent of a human driver. When utilized to pick up passengers such as children, elderly riders, or others, the AVs may be commissioned by a third party that arranges transportation for the rider. In some instances, a ride hail company may be used to coordinate a fleet of AVs for the passenger pickup, navigation, and drop off. When guardians of young or capacity-limited riders arrange for transportation, current ride hail systems do not uniquely identify ride hail passengers using provided biometric information that can assist to uniquely identify riders to the ride hail system.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example computing environment in which techniques and structures for providing the systems and methods disclosed herein may be implemented.

FIG. 2 illustrates a biometric authentication and occupant monitoring interface diagram in accordance with the present disclosure.

FIG. 3 illustrates a functional schematic of an example architecture of an automotive control system that may be used for control of an autonomous vehicle in accordance with the present disclosure.

FIG. 4 illustrates a mixed flow diagram for autonomous vehicle rider authentication, boarding, and drop off confirmation in accordance with the present disclosure.

FIG. 5 depicts a flow diagram of an example method for controlling an autonomous vehicle in accordance with the present disclosure.

FIG. 6 depicts a flow diagram of another example method for controlling an autonomous vehicle in accordance with the present disclosure.

### DETAILED DESCRIPTION

### Overview

Embodiment of the present disclosure describe systems and methods that assist a booking user to schedule an autonomous vehicle pick up another user and ensure the identity of the user being picked up by sending a confirmation to the booking user, an autonomous vehicle biometric rider ID system is described that can include Internet of Things (IoT) technology, where the system software may use autonomous vehicle system components such as microphones, cameras and sensors, to send automatic voice/image/text messages to the booking user. The system may allow both the rider(s) and booking user to be connected by in-vehicle or external software available in the vehicle to inform the booking user that the rider has boarded.

### Illustrative Embodiments

The disclosure will be described more fully hereinafter with reference to the accompanying drawings, in which example embodiments of the disclosure are shown, and not intended to be limiting.

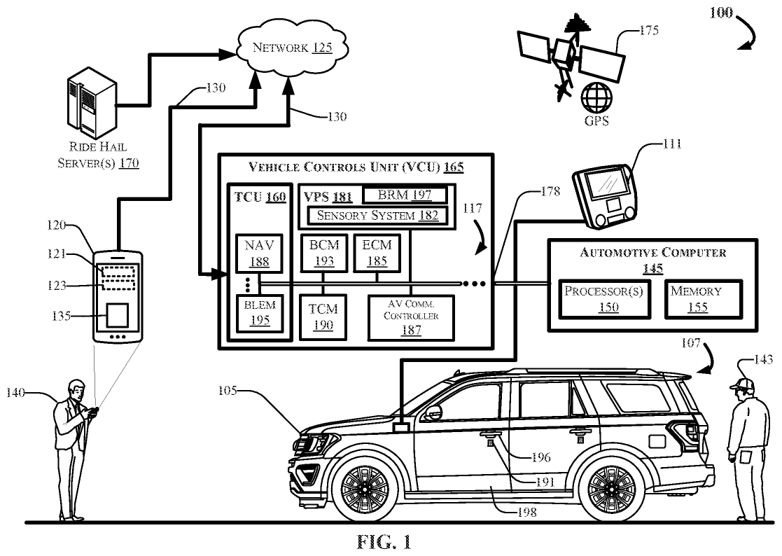

FIG. 1 depicts an example computing environment 100 that can include a vehicle 105. The vehicle 105 may include an automotive computer 145, and a Vehicle Controls Unit (VCU) 165 that can include a plurality of Electronic Control Units (ECUs) 117 disposed in communication with the automotive computer 145. A mobile device 120, which may be associated with a user 140 and the vehicle 105, may connect with the automotive computer 145 using wired and/or wireless communication protocols and transceivers. The mobile device 120 may be communicatively coupled with the vehicle 105 via one or more network(s) 125, which may communicate via one or more wireless connection(s) 130, and/or may connect with the vehicle 105 directly using Near Field Communication (NFC) protocols. Bluetooth® protocols. Wi-Fi. Ultra-Wide Band (UWB), and other possible data connection and sharing techniques.

The vehicle 105 may also receive and/or be in communication with a Global Positioning System (GPS) 175. The GPS 175 may be a satellite system (as depicted in FIG. 1) such as the Global Navigation Satellite System (GLNSS), Galileo, or navigation or other similar system. In other aspects, the GPS 175 may be a terrestrial-based navigation network. In some embodiments, the vehicle 105 may utilize a combination of GPS and Dead Reckoning responsive to determining that a threshold number of satellites are not recognized.

The automotive computer 145 may be or include an electronic vehicle controller, having one or more processor(s) 150 and memory 155. The automotive computer 145 may, in some example embodiments, be disposed in communication with the mobile device 120, and one or more ride hail server(s) 170. The ride hail server(s) 170 may be part of a cloud-based computing infrastructure, and may be associated with and/or include a Telematics Service Delivery Network (SDN) that provides digital data services to the vehicle 105 and other vehicles (not shown in FIG. 1) that may be part of a vehicle fleet.

Although illustrated as a sport utility, the vehicle 105 may take the form of another passenger or commercial automobile such as, for example, a car, a truck, a crossover vehicle, a van, a minivan, a taxi, a bus, etc., and may be configured and/or programmed to include various types of automotive drive systems. Example drive systems can include various types of Internal Combustion Engines (ICEs) powertrains having a gasoline, diesel, or natural gas-powered combustion engine with conventional drive components such as, a transmission, a drive shaft, a differential, etc. In another configuration, the vehicle 105 may be configured as an Electric Vehicle (EV). More particularly, the vehicle 105 may include a Battery EV (BEV) drive system, or be configured as a Hybrid EV (HEV) having an independent onboard powerplant, a Plug-In HEV (PHEV) that includes a HEV powertrain connectable to an external power source, and/or includes a parallel or series hybrid powertrain having a combustion engine powerplant and one or more EV drive systems. HEVs may further include battery and/or supercapacitor banks for power storage, flywheel power storage systems, or other power generation and storage infrastructure. The vehicle 105 may be further configured as a Fuel Cell Vehicle (FCV) that converts liquid or solid fuel to usable power using a fuel cell, (e.g., a Hydrogen Fuel Cell Vehicle (HFCV) powertrain, etc.) and/or any combination of these drive systems and components.

Further, the vehicle 105 may be a manually driven vehicle, and/or be configured and/or programmed to operate in a fully autonomous (e.g., driverless) mode (e.g., Level-5 autonomy) or in one or more partial autonomy modes which may include driver assist technologies. Examples of partial autonomy (or driver assist) modes are widely understood in the art as autonomy Levels 1 through 4.

A vehicle having a Level-0 autonomous automation may not include autonomous driving features.

A vehicle having Level-1 autonomy may include a single automated driver assistance feature, such as steering or acceleration assistance. Adaptive cruise control is one such example of a Level-1 autonomous system that includes aspects of both acceleration and steering.

Level-2 autonomy in vehicles may provide driver assist technologies such as partial automation of steering and acceleration functionality, where the automated system(s) are supervised by a human driver that performs non-automated operations such as braking and other controls. In some aspects, with Level-2 autonomous features and greater, a primary user may control the vehicle while the user is inside of the vehicle, or in some example embodiments, from a location remote from the vehicle but within a control zone extending up to several meters from the vehicle while it is in remote operation.

Level-3 autonomy in a vehicle can provide conditional automation and control of driving features. For example. Level-3 vehicle autonomy may include “environmental detection” capabilities, where the Autonomous Vehicle (AV) can make informed decisions independently from a present driver, such as accelerating past a slow-moving vehicle, while the present driver remains ready to retake control of the vehicle if the system is unable to execute the task.

Level-4 AVs can operate independently from a human driver, but may still include human controls for override operation. Level-4 automation may also enable a self-driving mode to intervene responsive to a predefined conditional trigger, such as a road hazard or a system failure.

Level-5 AVs may include fully autonomous vehicle systems that require no human input for operation, and may not include human operational driving controls.

According to embodiments of the present disclosure, the Rider Bio-ID system 107 may be configured and/or programmed to operate with a vehicle having a Level-4 or Level-5 autonomous vehicle controller. Accordingly, the autonomous vehicle Rider Biometric Identification (ID) system 107 (hereafter Rider Bio-ID System 107) may provide some aspects of human control to the vehicle 105, when the vehicle is configured as an AV.

The mobile device 120 can include a memory 123 for storing program instructions associated with an application 135 that, when executed by a mobile device processor 121, performs aspects of the disclosed embodiments. The application (or “app”) 135 may be part of the Rider Bio-ID system 107, or may provide information to the Rider Bio-ID system 107 and/or receive information from the Rider Bio-ID system 107.

In some aspects, the mobile device 120 may communicate with the vehicle 105 through the one or more wireless connection(s) 130, which may be encrypted and established between the mobile device 120 and a Telematics Control Unit (TCU) 160. The mobile device 120 may communicate with the TCU 160 using a wireless transmitter (not shown in FIG. 1) associated with the TCU 160 on the vehicle 105. The transmitter may communicate with the mobile device 120 using a wireless communication network such as, for example, the one or more network(s) 125. The wireless connection(s) 130 are depicted in FIG. 1 as communicating via the one or more network(s) 125.

The network(s) 125 illustrate an example communication infrastructure in which the connected devices discussed in various embodiments of this disclosure may communicate. The network(s) 125 may be and/or include the Internet, a private network, public network or other configuration that operates using any one or more known communication protocols such as, for example, Transmission Control Protocol/Internet Protocol (TCP/IP). Bluetooth®, BLE®, Wi-Fi based on the Institute of Electrical and Electronics Engineers (IEEE) standard 802.11. UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The automotive computer 145 may be installed in an engine compartment of the vehicle 105 (or elsewhere in the vehicle 105) and operate as a functional part of the Rider Bio-ID system 107, in accordance with the disclosure. The automotive computer 145 may include one or more processor(s) 150 and a computer-readable memory 155.

The one or more processor(s) 150 may be disposed in communication with one or more memory devices disposed in communication with the respective computing systems (e.g., the memory 155 and/or one or more external databases not shown in FIG. 1). The processor(s) 150 may utilize the memory 155 to store programs in code and/or to store data for performing aspects in accordance with the disclosure. The memory 155 may be a non-transitory computer-readable memory storing a Rider Bio-ID program code. The memory 155 can include any one or a combination of volatile memory elements (e.g., Dynamic Random Access Memory (DRAM). Synchronous Dynamic Random-Access Memory (SDRAM), etc.) and can include any one or more nonvolatile memory elements (e.g., Erasable Programmable Read-Only Memory (EPROM), flash memory, Electrically Erasable Programmable Read-Only Memory (EEPROM), Programmable Read-Only Memory (PROM), etc.

The VCU 165 may share a power bus 178 with the automotive computer 145, and may be configured and/or programmed to coordinate the data between vehicle 105 systems, connected servers (e.g., the ride hail server(s) 170), and other vehicles (not shown in FIG. 1) operating as part of a vehicle fleet. The VCU 165 can include or communicate with any combination of the ECUs 117, such as, for example, a Body Control Module (BCM) 193, an Engine Control Module (ECM) 185, a Transmission Control Module (TCM) 190, the TCU 160, a Body and AV communication controller 187, etc. The VCU 165 may further include and/or communicate with a Vehicle Perception System (VPS) 181, having connectivity with and/or control of a biometric recognition module (BRM) 197, and having connectivity with and/or control of one or more vehicle sensory system(s) 182. In some aspects, the VCU 165 may control operational aspects of the vehicle 105, and implement one or more instruction sets received from the application 135 operating on the mobile device 120, from one or more instruction sets stored in computer memory 155 of the automotive computer 145, including instructions operational as part of the Rider Bio-ID system 107.

The TCU 160 can be configured and/or programmed to provide vehicle connectivity to wireless computing systems onboard and offboard the vehicle 105, and may include a Navigation (NAV) receiver 188 for receiving and processing a GPS signal from the GPS 175, a BLE® Module (BLEM) 195, a Wi-Fi transceiver, a UWB transceiver, and/or other wireless transceivers (not shown in FIG. 1) that may be configurable for wireless communication between the vehicle 105 and other systems, computers, and modules. The TCU 160 may be disposed in communication with the ECUs 117 by way of a bus 180. In some aspects, the TCU 160 may retrieve data and send data as a node in a CAN bus.

The BLEM 195 may establish wireless communication using Bluetooth® and BLE® communication protocols by broadcasting and/or listening for broadcasts of small advertising packets, and establishing connections with responsive devices that are configured according to embodiments described herein. For example, the BLEM 195 may include Generic Attribute Profile (GATT) device connectivity for client devices that respond to or initiate GATT commands and requests, and connect directly with the mobile device 120, and/or one or more keys, which may include, for example, a fob (not shown in FIG. 1).

The bus 180 may be configured as a Controller Area Network (CAN) bus organized with a multi-master serial bus standard for connecting two or more of the ECUs 117 as nodes using a message-based protocol that can be configured and/or programmed to allow the ECUs 117 to communicate with each other. The bus 180 may be or include a high speed CAN (which may have bit speeds up to 1 Mb/s on CAN. 5 Mb/s on CAN Flexible Data Rate (CAN FD)), and can include a low-speed or fault tolerant CAN (up to 125 Kbps), which may, in some configurations, use a linear bus configuration. In some aspects, the ECUs 117 may communicate with a host computer (e.g., the automotive computer 145, the Rider Bio-ID system 107, and/or the ride hail server(s) 170, etc.), and may also communicate with one another without the necessity of a host computer. The bus 180 may connect the ECUs 117 with the automotive computer 145 such that the automotive computer 145 may retrieve information from, send information to, and otherwise interact with the ECUs 117 to perform steps described according to embodiments of the present disclosure. The bus 180 may connect CAN bus nodes (e.g., the ECUs 117) to each other through a two-wire bus, which may be a twisted pair having a nominal characteristic impedance. The bus 180 may also be accomplished using other communication protocol solutions, such as Media Oriented Systems Transport (MOST) or Ethernet. In other aspects, the bus 180 may be a wireless intra-vehicle bus.

The VCU 165 may control various loads directly via the bus 180 communication or implement such control in conjunction with the BCM 193. The ECUs 117 described with respect to the VCU 165 are provided for example purposes only, and are not intended to be limiting or exclusive. Control and/or communication with other control modules not shown in FIG. 1 is possible, and such control is contemplated.

In an example embodiment, the ECUs 117 may control aspects of vehicle operation and communication using inputs from human drivers, inputs from an autonomous vehicle controller, the Rider Bio-ID system 107, and/or via wireless signal inputs received via the wireless connection(s) 130 from other connected devices such as the mobile device 120, among others. The ECUs 117, when configured as nodes in the bus 180, may each include a central processing unit (CPU), a CAN controller, and/or a transceiver (not shown in FIG. 1). For example, although the mobile device 120 is depicted in FIG. 1 as connecting to the vehicle 105 via the BLEM 195, it is possible and contemplated that the wireless connection may also or alternatively be established between the mobile device 120 and one or more of the ECUs 117 via the respective transceiver(s) associated with the module(s).

The BCM 193 generally includes integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 193 may also operate as a gateway for bus and network interfaces to interact with remote ECUs (not shown in FIG. 1).

The BCM 193 may coordinate any one or more functions from a wide range of vehicle functionality, including energy management systems, alarms, vehicle immobilizers, driver and rider access authorization systems, Phone-as-a-Key (PaaK) systems, driver assistance systems. AV control systems, power windows, doors, actuators, and other functionality, etc. The BCM 193 may be configured for vehicle energy management, exterior lighting control, wiper functionality, power window and door functionality, heating ventilation and air conditioning systems, and driver integration systems. In other aspects, the BCM 193 may control auxiliary equipment functionality, and/or be responsible for integration of such functionality.

In some aspects, the vehicle 105 may include one or more Door Access Panels (DAPs) 191 disposed on exterior door surface(s) of vehicle door(s) 198, and connected with a DAP controller (not shown in FIG. 1). In some aspects, the user 140 may have the option of entering a vehicle by typing in a personal identification number (PIN) on an exterior interface associated with a vehicle. The user interface may be included as part of a Door Access Panel (DAP) 191, a wireless keypad, included as a part of the mobile device 120, or included as part of another interface. The DAP 191, which may operate and/or communicate with the AV communication controller 187 or another of the ECUs 117, can include and/or connect with an interface with which a ride hail passenger, user, (or any other user such as the user 140) may input identification credentials and receive information from the system. In one aspect, the interface may be or include a DAP 191 disposed on a vehicle door 198, and can include an interface device from which the user can interact with the system by selecting their unique identifier from a list, and by entering personal identification numbers (PINs) and other non-personally identifying information. In some embodiments, the interface may be a mobile device, a keypad, a wireless or wired input device, a vehicle infotainment system, and/or the like. Accordingly, it should be appreciated that, although a DAP 191 is described with respect to embodiments herein, the interface may alternatively be one or more other types of interfaces described above.

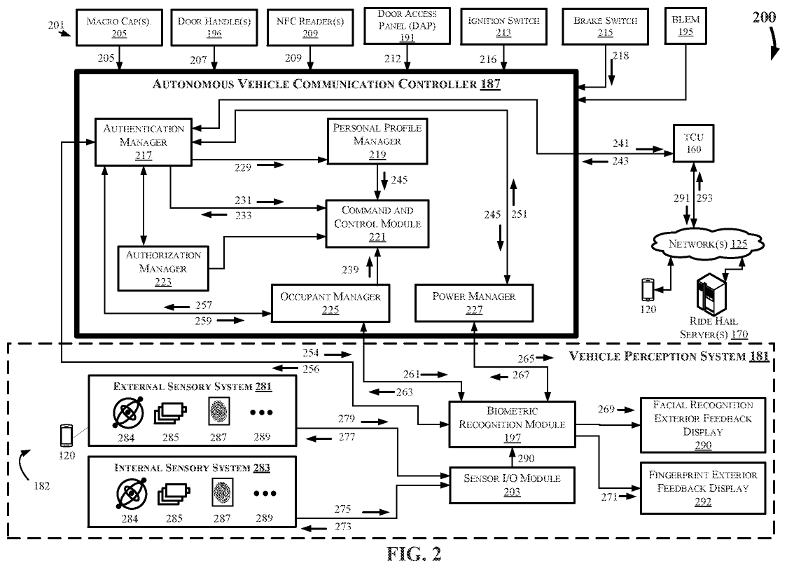

The AV communication controller 187, described in greater detail with respect to FIG. 2, can include sensory and processor functionality and hardware to facilitate user and device authentication, and provide occupant customizations and support that provide customized experiences for vehicle occupants. The AV communication controller 187 may be configured and/or programmed to provide biometric authentication controls, including, for example, facial recognition, fingerprint recognition, voice recognition, and/or other information associated with characterization, identification, and/or verification for other human factors such as gait recognition, body heat signatures, eye tracking, etc.

FIG. 2 illustrates a functional schematic of an example architecture of a biometric authentication and occupant monitoring system 200 that may be used for providing vehicle entry and signal authentication using biometric information and other human factors, and for providing user support and customization for the vehicle 105, in accordance with the present disclosure.

The biometric authentication and occupant monitoring system 200 may authenticate passive device signals from a Passive Entry Passive Start (PEPS)-configured device such as the mobile device 120, a passive key device such as a fob (not shown), and provide vehicle entry and signal authentication using biometric information and other human factors. The biometric and occupant monitoring system 200 may also provide user support and customizations to enhance user experience with the vehicle 105. The authentication and occupant monitoring system 200 can include the AV communication controller 187, which may be disposed in communication with the TCU 160, the BLEM 195, and a plurality of other vehicle controllers 201, which may include vehicle sensors, input devices, and mechanisms. Examples of the plurality of other vehicle controllers 201 can include, one or more macro capacitor(s) 205 that may send vehicle wakeup data 206, the door handle(s) 196 that may send PEPS wakeup data. NFC reader(s) 209 that send NFC wakeup data 210, the DAPs 191 that send DAP wakeup data 212, an ignition switch 213 that can send an ignition switch actuation signal 216, and/or a brake switch 215 that may send a brake switch confirmation signal 218, among other possible components.

The internal and external sensory systems 283 and 281 may provide the sensory data 279 obtained from the external sensory system 281 and the sensory data 275 from the internal sensory system 283 responsive to an internal sensor request message 273 and an external sensor request message 277, respectively. The sensory data 279 and 275 may include information from any of the sensors 284-289, where the external sensor request message 277 and/or the internal sensor request message 273 can include the sensor modality with which the respective sensor system(s) are to obtain the sensory data.

The camera sensor(s) 285 may include thermal cameras, optical cameras, and/or a hybrid camera having optical, thermal, or other sensing capabilities. Thermal cameras may provide thermal information of objects within a frame of view of the camera(s), including, for example, a heat map figure of a subject in the camera frame. An optical camera may provide a color and/or black-and-white image data of the target(s) within the camera frame. The camera sensor(s) 285 may further include static imaging, or provide a series of sampled data (e.g., a camera feed) to the biometric recognition module 197.

The IMU(s) 284 may include a gyroscope, an accelerometer, a magnetometer, or other inertial measurement device. The fingerprint sensor(s) 287 can include any number of sensor devices configured and/or programmed to obtain fingerprint information. The fingerprint sensor(s) 287 and/or the IMU(s) 284 may also be integrated with and/or communicate with a passive key device, such as, for example, the mobile device 120 and/or the fob (not shown in FIG. 2). The fingerprint sensor(s) 287 and/or the IMU(s) 284 may also (or alternatively) be disposed on a vehicle exterior space such as the engine compartment (not shown in FIG. 2), door panel (not shown in FIG. 2), etc. In other aspects, when included with the internal sensory system 283, the IMU(s) 284 may be integrated in one or more modules disposed within the vehicle cabin or on another vehicle interior surface.

The biometric recognition module 197 may be disposed in communication with one or more facial recognition exterior feedback displays 290 connecting with a sensor I/O module 203, which can operate as a user interface accessible to the user 140 outside of the vehicle 105 to provide facial recognition feedback information 269 associated with facial recognition processes described herein. The biometric recognition module 197 may further connect with one or more fingerprint exterior feedback displays 292 that may perform similar communication functions associated with fingerprint recognition processes described herein, including providing fingerprint authentication feedback information 271 to the fingerprint exterior feedback displays 292 accessible to the user 140 outside of the vehicle 105 (also referred to in conjunction with the fingerprint exterior feedback display 292 as “feedback displays”). It should be appreciated that the feedback displays 290 and/or 292 may be and/or include a stationary I/O or other display disposed on the vehicle, the mobile device 120, the fob, and/or some other wired or wireless device.

The AV communication controller 187 can include an authentication manager 217, a personal profile manager 219, a command and control module 221, an authorization manager 223, an occupant manager 225, and a power manager 227, among other control components.

The authentication manager 217 may communicate biometric key information 254 to the ride hail server(s) 170. The biometric key information 254 can include biometric mode updates indicative of a particular modality with which the internal and/or external sensory systems 283 and 281 are to obtain sensory data. The biometric key information 254 may further include an acknowledgement of communication received from the biometric recognition module 197, an authentication status update including, for example, biometric indices associated with user biometric data, secured channel information, biometric location information, and/or other information. In some aspects, the authentication manager 217 may receive biometric key administration requests 256 and other responsive messages from the biometric recognition module 197, which can include, for example, biometric mode message responses and/or other acknowledgements.

The authentication manager 217 may further connect with the TCU 160 and communicate biometric status payload information 241 to the TCU 160 indicative of the biometric authentication status of the user 140, requests for key information, profile data, and other information. The TCU 160 may send and/or forward digital key payload 291 to the ride hail server(s) 170 via the network(s) 125, and receive digital key status payload 293 from the ride hail server(s) 170 and provide responsive messages and/or commands to the authentication manager 217 that can include biometric information payload 243.

Moreover, the authentication manager 217 may be disposed in communication with the BLEM 195, and/or the other vehicle controllers 201 according to embodiments described in the present disclosure. For example, the BCM 193 may send an initiating signal indicating that one or more components should transition from a low-power mode to a ready mode.

The authentication manager 217 may also connect with the personal profile manager 219, and the power manager 227. The personal profile manager 219 may perform data management associated with user profiles, which may be stored in the automotive computer 145 and/or stored on the ride hail server(s) 170. For example, the authentication manager 217 may send occupant seat position information 229 to the personal profile manager 219, which may include a seat position index (not shown in FIG. 2) indicative of preferred and/or assigned seating for passengers of the vehicle 105. The personal profile manager 219 may update seating indices, delete and create profiles, and perform other administrative duties associated with individualized user profile management.

The power manager 227 may receive power control commands from the authentication manager 217, where the power control commands are associated with biometric authentication device management including, for example, device wakeup causing the biometric recognition module 197 to transition from a low power (standby mode) state to a higher power (e.g., active mode) state. The power manager 227 may send power control acknowledgements 251 to the authentication manager 217 responsive to the control commands 245. For example, responsive to the power and control commands 245 received from the authentication manager 217, the power manager 227 may generate a power control signal 265 and send the power control signal to the biometric recognition module 197. The power control signal 265 may cause the biometric recognition module 197 to change power states (e.g., wakeup, etc.). The biometric recognition module 197 may send a power control signal response 267 to the power manager 227 indicative of completion of the power control signal 265.

The authentication manager 217 and/or the personal profile manager 219 may further connect with the command and control module 221, which may be configured and/or programmed to manage user permission levels, and control vehicle access interface(s) (not shown in FIG. 2) for interfacing with vehicle users. The command and control module 221 may be and/or include, for example, the BCM 193 described with respect to FIG. 1. For example, the authentication manager 217 may send command and control authentication information 231 that cause the command and control module 221 to actuate one or more devices according to successful or unsuccessful authentication of a device, a signal, a user, etc. The command and control module 221 may send acknowledgements 233 and other information including, for example, vehicle lock status.

The occupant manager 225 may connect with the authentication manager 217, and communicate occupant change information 257 indicative of occupant changes in the vehicle 105 to the authentication manager 217. For example, when occupants enter and exit the vehicle 105, the occupant manager 225 may update an occupant index (not shown in FIG. 2), and transmit the occupant index as part of the occupant change information 257 to the authentication manager. The occupant manager 225 may further connect with the occupant manager 536 to update the occupant manager 225 with seat indices 259, which may include confirmation messages for seat index changes, and occupant entries and exits from the vehicle 105.

The occupant manager 225 may also receive seat indices 259 from the authentication manager 217, which may index seating arrangements, positions, preferences, and other information.

The occupant manager 225 may also connect with the command and control module 221. The command and control module 221 may receive adaptive vehicle control information 239 from the occupant manager 225, which may communicate and/or include settings for vehicle media settings, seat control information, occupant device identifiers, and other information.

The occupant manager 225 may communicate biometric mode update information 261 to the biometric recognition module 197, which may include instructions and commands for utilizing particular modalities of biometric data collection from the internal sensory system 283 and/or the external sensory system 281. The occupant manager 225 may further receive occupant status update information and/or occupant appearance update information (collectively shown as information 263 in FIG. 2) from the biometric recognition module 197.

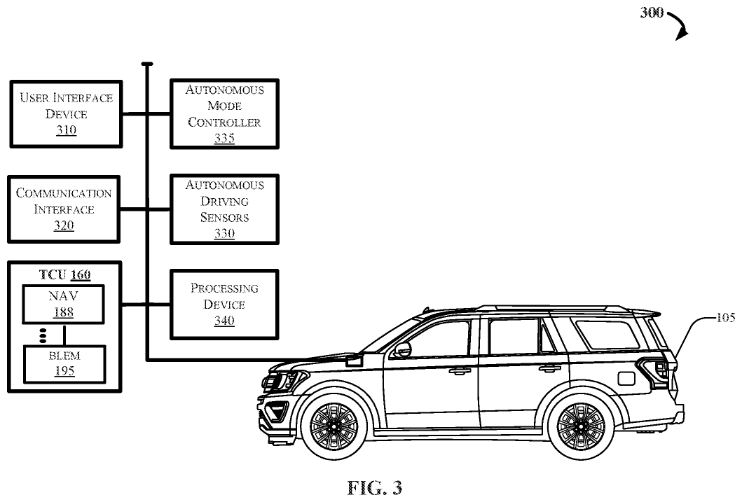

FIG. 3 illustrates a functional schematic of an example architecture of an automotive control system 300 that may be used for control of the vehicle 105, in accordance with the present disclosure. The automotive control system 300 can include a user interface 310, a navigation system 315, a communication interface 320, autonomous driving sensors 330, an AV controller 335, and one or more processing device(s) 340.

The user interface 310 may be configured or programmed to present information to a user such as, for example, the user 140 depicted with respect to FIG. 1, during operation of the vehicle 105. Moreover, the user interface 310 may be configured or programmed to receive user inputs, and thus, it may be disposed in or on the vehicle 105 such that it is viewable and may be interacted with by a passenger or operator. For example, in one embodiment where the vehicle 105 is a passenger vehicle, the user interface 310 may be located in the passenger compartment. In another possible application, the user interface 310 may be attached to another operational mechanism that may be within tactile reach of a passenger or driver of the vehicle. In one possible approach, the user interface 310 may include a touch-sensitive display screen (not shown in FIG. 3).

The navigation system 315 may be configured and/or programmed to determine a position of the autonomous vehicle 105. The navigation system 315 may include a Global Positioning System (GPS) receiver configured or programmed to triangulate the position of the vehicle 105 relative to satellites or terrestrial based transmitter towers. The navigation system 315, therefore, may be configured or programmed for wireless communication. The navigation system 315 may be further configured or programmed to develop routes from a current location to a selected destination, as well as display a map and present driving directions to the selected destination via, e.g., the communication interface 320. In some instances, the navigation system 315 may develop the route according to a user preference. Examples of user preferences may include maximizing fuel efficiency, reducing travel time, travelling the shortest distance, or the like.

The communication interface 320 may be configured or programmed to facilitate wired and/or wireless communication between the components of the vehicle 105 and other devices, such as a remote server (not shown in FIG. 3), or another vehicle (not shown in FIG. 3) when using a vehicle-to-vehicle communication protocol. The communication interface 320 may also be configured and/or programmed to communicate directly from the vehicle 105 to the mobile device 120 using any number of communication protocols such as Bluetooth®, Bluetooth Low Energy®, UWB, or Wi-Fi.

The TCU 160 may include wireless transmission and communication hardware that may be disposed in communication with one or more transceivers associated with telecommunications towers and other wireless telecommunications infrastructure (not shown in FIG. 3). For example, the TCU 160 may be configured and/or programmed to receive messages from, and transmit messages to one or more cellular towers associated with a telecommunication provider, and/or a Telematics Service Delivery Network (SDN) associated with the vehicle 105 (such as, for example, the ride hail server(s) 170 depicted with respect to FIG. 1). In some examples, the SDN may establish communication with a mobile device (e.g., the mobile device 120 depicted with respect to FIG. 1) operable by a user, which may be and/or include a cell phone, a tablet computer, a laptop computer, a key fob, or any other electronic device. An internet connected device such as a PC, Laptop, Notebook, or Wi-Fi connected mobile device, or another computing device may establish cellular communications with the telematics transceiver 325 through the SDN.

The communication interface 320 may also communicate using one or more vehicle-to-vehicle communications technologies. An example of a vehicle-to-vehicle communication protocol may include, for example, a dedicated short-range communication (DSRC) protocol. Accordingly, the communication interface 320 may be configured or programmed to receive messages from and/or transmit messages to a remote server (e.g., the ride hail server(s) 170 depicted with respect to FIG. 1) and/or other autonomous, semi-autonomous, or manually-driven vehicles (not shown in FIG. 3).

The autonomous driving sensors 330 may include any number of devices configured or programmed to generate signals that help navigate the vehicle 105 while the vehicle 105 is operating in the autonomous (e.g., driverless) mode. Examples of autonomous driving sensors 330 may include a Radio Detection and Ranging (RADAR or “radar”) sensor configured for detection and localization of objects using radio waves, a Light Detecting and Ranging (LiDAR or “lidar”) sensor, a vision sensor system having trajectory, obstacle detection, object classification, augmented reality, and/or other capabilities, and/or the like. The autonomous driving sensors 330 may help the vehicle 105 “see” the roadway and the vehicle surroundings and/or negotiate various obstacles while the vehicle is operating in the autonomous mode.

The autonomous mode controller 335 may be configured or programmed to control one or more vehicle subsystems while the vehicle is operating in the autonomous mode. Examples of subsystems that may be controlled by the autonomous mode controller 335 may include one or more systems for controlling braking, ignition, steering, acceleration, transmission control, and/or other control mechanisms. The autonomous mode controller 335 may control the subsystems based, at least in part, on signals generated by the autonomous driving sensors 330.

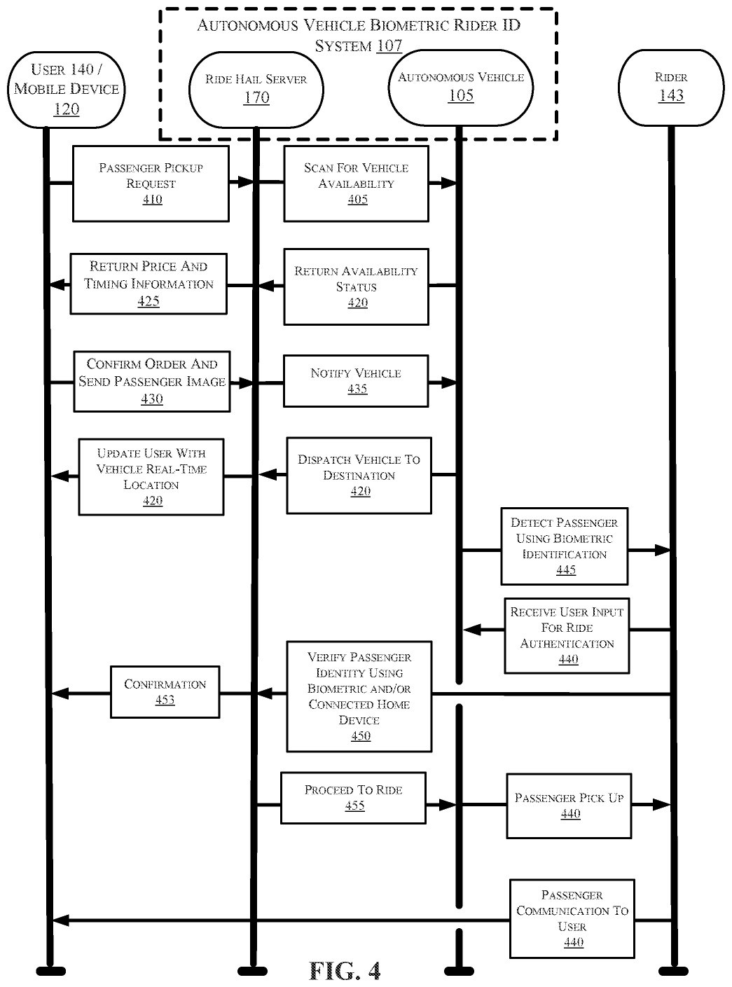

FIG. 4 illustrates a mixed flow diagram for autonomous vehicle rider authentication, boarding, and drop off confirmation in accordance with the present disclosure. Embodiment of the present disclosure may include communication between three entities: the rider bio-ID system 107, the rider(s) 143, and the user who orders the ride (the payer). The user is therefore described with respect to the user computing device such as the mobile device 120. In some embodiments, instead of a mobile device, the user computing device may be a desktop computing device, a smart watch or other wearable, a tablet, or the like.

The payer described herein is understood as the user. In one aspect, the user 140 may obtain a voice sample of the rider 143, identification number or the like (for pets, tag ID), a rider image, a rider's finger print information, an iris scan, or other biometric information, and make the biometric and identification information available to the rider bio-ID system 107.

The Rider Bio-ID system 107 may also connect to the payer's smart home (not shown in FIG. 4) or in-vehicle devices including (Amazon® Alexa®, Google Home®, and/or the like, also not shown in FIG. 4), which may be used in conjunction with the Rider Bio-ID system 107 to verify the authenticity of the rider(s) 143.

As shown in FIG. 4, at block 410 the user 140 may use an online tool (not shown in FIG. 4), such as an application, to send a booking request to the service provider operating the ride hail server 170. In essence, the payer/user 140 provides the information required for the Rider Bio-ID system 107 to identify the rider(s) 143.

Within the Rider Bio-ID system 107, cloud-connected ride hail server 170 may communicate with the autonomous vehicle 105 registered to and/or operating as part of a ride hail service. At block 405, the ride hail server 170 may scan for vehicle availability by sending status requests to fleet vehicles (fleet not shown in FIG. 4) to find an available AV. At step 420, the AV 105 may return availability of its current status, which may be, for example, busy, available, or busy with an available time estimation.

At step 425, the ride hail server 170 may forward price and time information to the user mobile device 120. At step 430, the user 140 may enter a confirmation of the order and send passenger images and other biometric authentication information. The communication can include transfer of user-associated data usable by the cloud-connected ride hail server 170 and/or the AV 105 to identify the rider 143 via biometric identifiers. For example, confirmation of the order at step 430 can include images of the rider 143, voice sample(s) of the rider's voice, rider fingerprint information, etc. The Rider Bio-ID system 107 may further receive information associated with physical identification cards, radio frequency identification device (RFID) tags, or other ID's associated with the rider 143, where the identification information may be usable to uniquely identify the rider 143.

At step 435, the ride hail server 170 may notify the AV 105 by initiating a ride hail pickup communication. The ride hail pickup communication may include at least one biometric identifier from step 430 that may be usable to uniquely identify the rider 143 when the AV reaches the pickup destination. The Rider Bio-ID system 107 may acknowledge the request and retrieve/store the data associated with the rider 143 who is to be picked up at the pickup destination once that location is reached by the AV 105.

At step 420, responsive to the vehicle notification step 435, the AV 105 may dispatch to the destination for the rider 143 pickup. The Rider Bio-ID system 107 may further send a confirmation back to the user computing device from the service upon successful arrival of the person at the destination. For example, at step 420, the ride hail server 170 may send an update with vehicle real-time location, including an estimated time of arrival at the passenger pickup location.

The autonomous vehicle, after reaching the pickup location, may send a “reached pickup location” signal to the ride hail server 170, which may log the time of the arrival, and/or forward an arrival notice to the user 140 (not shown in FIG. 4).

After arrival at the pickup location, at step 445, the AV 105 may continuously scan the pickup location to identify the passenger, and detect the passenger using biometric identification. This step may include 1) outputting a viewable/audible message to acquire the attention of the rider 143, 2) request a second biometric sample from the rider 143 once such connection is made with the rider, and 3) receive the second biometric sample from the rider for comparison and verification of the identity.

Considering these steps in greater detail, after arriving at the pickup destination, the AV may present one or more identifying messages that may be identifiable by the rider 143. Such identifying messages may include a vehicle name, a vehicle number, a rider name, a rider number, a code message known only by the rider and the user 140, or another identifiable message. The Rider Bio-ID system 107 may also utilize object detection methodologies to localize and target individuals located in the vicinity of the pickup location. Accordingly, the AV may scan people or groups of people to identify biometric identifiers of bystanders that may be or have more than a threshold probability of being a match with biometric markers associated with the rider 143. For example, in addition to output of a notification message by displaying the message on an output display (e.g., a sign disposed on the top of the vehicle) and/or with a text/voice/image-based messaging mechanism, the AV may scan faces of bystanders proximate the vehicle 105 to identify possible matches with the rider 143. The vehicle 105 may locate and approach the rider 143, and/or the rider 143 may locate and/or approach the vehicle 105.

After connection with the rider 143, at step 445 the AV 105 may authenticate the rider 143 using biometric identification received from the user 140 during the order confirmation step 430. The Rider Bio-ID system 107 may request a voice sample, a finger print, and/or obtain an image of the rider 143 at step 440. The rider 143 may provide a fingerprint sample and/or provide a clear field of view of their facial features to the external sensory system 281 and/or the internal sensory system 283. The biometric recognition module 197 may take the secondary biometric identifier obtained from the rider 143 by the AV 105, communicate the biometric identifier information to the AV communication controller 187, and determine that the rider 143 biometric identifier matches that of the first biometric information associated with the rider 143.

At step 450, the ride hail server 170 may also verify the passenger identity using biometric and/or connected home devices operable in the vehicle 105. For example, in lieu of using onboard devices, the identity may be matched using the ride hail server 170.

The vehicle upon successfully identification of the person, at step 453 the ride hail server 170 sends the communication to the user computing device 120, and proceeds to allow the rider 143 to board the vehicle 105. The ride hail server orixz may then cause control of the AV 105 to transport the rider 143 to the destination based on the ride hail pickup communication and the identity verification result.

As the AV proceeds to the drop off destination, the rider 143 may communicate with the user 140 via wireless calling and/or video chat. In other aspects, the rider 143 may communicate with the user 140 via the in-vehicle communication system. For example, the AV 105 may receive, via the AV infotainment system 111 (depicted in FIG. 1), an audio communication to the rider 143, and open a communication channel connecting a user computing device (e.g., the mobile device 120) with the AV infotainment system 111. The AV 105 may provide the communication channel(s) for one or more of an audio communication and a video communication between the rider 143 and the user 140. The user 140 may also choose to view the vehicle's cabin through the vehicle's cameras (e.g., the internal sensory system 283) while the AV 105 is on its way to the destination, and can initiate a call as well to communicate with the rider(s) 143. Upon the discretion of the user (who may also be the payor), the rider 143 can be allowed to use paid services in the AV 105 such as ordering a meal or watching a movie via the AV infotainment system 111. Paid services may include audio entertainment, video entertainment, and refreshment provisions for the rider.

While the rider is content with their ride, the user 140 may receive a real-time localization feed, where the real-time localization feed provides a real-time location of the AV, and may further include views and/or video feed of the cabin interior as the rider 143 proceeds to their destination.

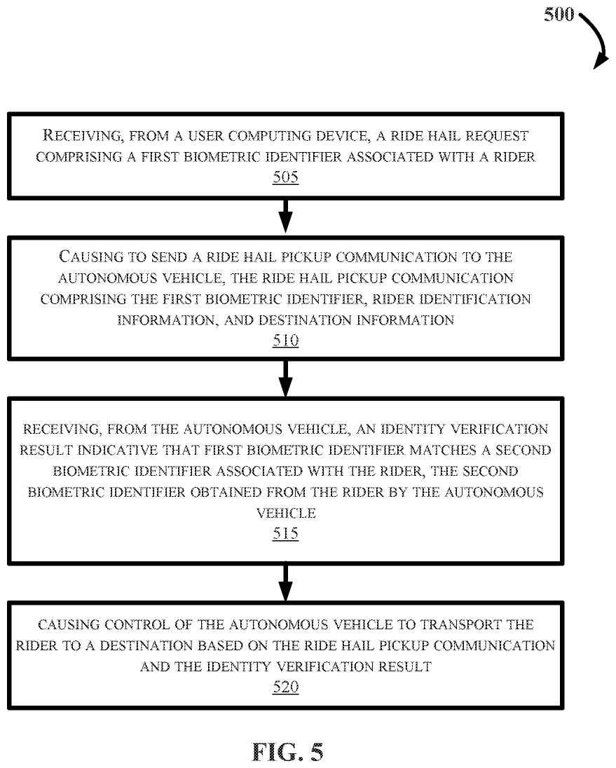

FIG. 5 is a flow diagram of an example method 500 for controlling an AV, according to the present disclosure. FIG. 5 may be described with continued reference to prior figures, including FIGS. 1-4. The following process is exemplary and not confined to the steps described hereafter. Moreover, alternative embodiments may include more or less steps that are shown or described herein, and may include these steps in a different order than the order described in the following example embodiments.

Referring first to FIG. 5, at step 505, the method 500 may commence with receiving, from a user computing device, a ride hail request including a first biometric identifier associated with a rider.

At step 510, the method 500 may further include causing to send a ride hail pickup communication to the autonomous vehicle, the ride hail pickup communication comprising the first biometric identifier, rider identification information, and destination information.

At step 515, the method 500 may further include receiving, from the autonomous vehicle, an identity verification result indicative that first biometric identifier matches a second biometric identifier associated with the rider, the second biometric identifier obtained from the rider by the autonomous vehicle. This step may include obtaining the second biometric identifier via a vehicle-based object detection system. In other aspects, this step may include obtaining the second biometric identifier is obtained via a vehicle-based voice recognition system.

At step 520, the method 500 may further include causing control of the autonomous vehicle to transport the rider to a destination based on the ride hail pickup communication and the identity verification result. This step may include receiving, from the user computing device, an audio communication to the rider, opening a communication channel connecting the user computing device with the autonomous vehicle, and providing the communication channel for one or more of an audio communication and a video communication between the rider and the user.

This step may further include receiving, from the user computing device, an instruction to provide one or more paid services for the rider. The paid services may include audio entertainment, video entertainment, and refreshment provisions to the rider.

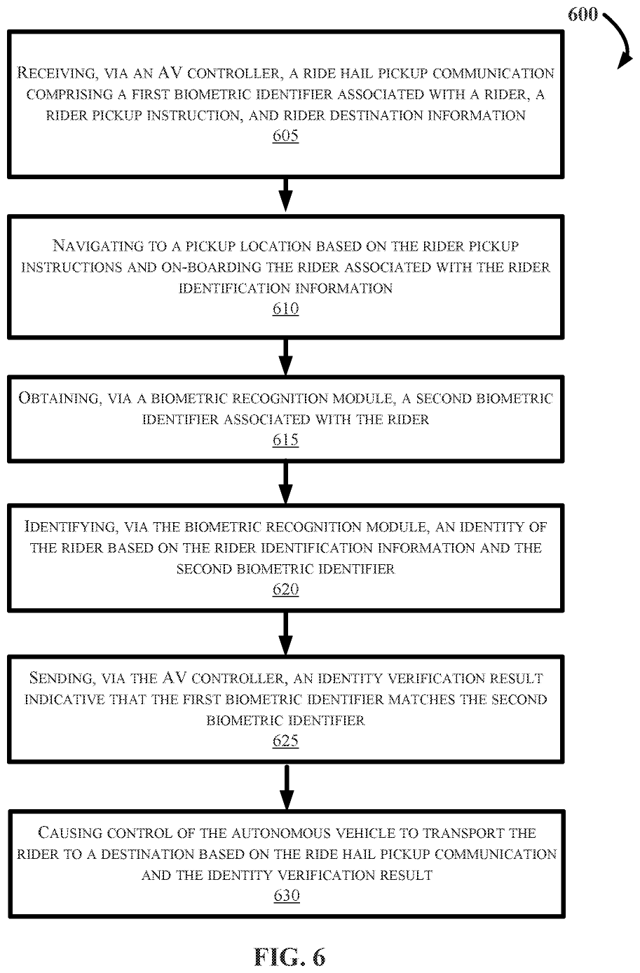

FIG. 6 is a flow diagram of an example method 600 for controlling an AV, according to the present disclosure. FIG. 6 may be described with continued reference to prior figures, including FIGS. 1-4. The following process is exemplary and not confined to the steps described hereafter. Moreover, alternative embodiments may include more or less steps that are shown or described herein, and may include these steps in a different order than the order described in the following example embodiments.

Referring first to FIG. 6, at step 605, the method 600 may commence with receiving, via an AV controller, a ride hail pickup communication from a ride hail server, the ride hail pickup communication comprising a first biometric identifier associated with a rider, a rider pickup instruction, and rider destination information.

At step 610, the method 600 may further include navigating to a pickup location based on the rider pickup instructions and on-boarding the rider associated with the ride identification information.

At step 615, the method 600 may further include obtaining, via a biometric recognition module, a second biometric identifier associated with the rider.

At step 620, the method 600 may further include identifying, via the biometric recognition module, an identity of the rider based on ride hail pickup communication and the second biometric identifier.

At step 625, the method 600 may further include sending, via the AV controller, an identity verification result indicative that the first biometric identifier matches the second biometric identifier.

At step 630, the method 600 may further include causing control of the AV to transport the rider to a destination based on the ride hail pickup communication and the identity verification result. This step may further include receiving, via a vehicle infotainment system, an audio communication to the rider, opening a communication channel connecting a user computing device with an autonomous vehicle infotainment system, and providing the communication channel for one or more of an audio communication and a video communication between the rider and the user.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method for controlling an autonomous vehicle, comprising:
receiving, from a user device, a ride hail request comprising a first biometric identifier associated with a rider;
causing to send a ride hail pickup communication to the autonomous vehicle, the ride hail pickup communication comprising the first biometric identifier, rider identification information, and destination information;
receiving, from the autonomous vehicle, an identity verification result indicative that the first biometric identifier matches a second biometric identifier associated with the rider, the second biometric identifier obtained from the rider by the autonomous vehicle; and
causing control of the autonomous vehicle to transport the rider to a destination based on the ride hail pickup communication and the identity verification result.

2. The method according to claim 1, further comprising.
receiving, from the user device, an audio communication from the rider;
opening a communication channel connecting the user device with the autonomous vehicle; and
providing the communication channel for communication between the rider and the user device.

3. The method according to claim 2, further comprising:
receiving, from the user device, an instruction to provide one or more paid services for the rider.

4. The method according to claim 3, wherein the paid services comprise audio entertainment, video entertainment, and refreshment provisions to the rider.

5. The method according to claim 1, further comprising:
receiving, from the autonomous vehicle, a real-time localization feed; and
causing to send the real-time localization feed to the user device.

6. The method according to claim 1, wherein the second biometric identifier is obtained via a vehicle-based object detection system.

7. The method according to claim 1, wherein the second biometric identifier is obtained via a vehicle-based voice recognition system.

8. A ride hail control system comprising:
a processor; and
a memory for storing executable instructions, the processor programmed to execute the instructions to:
receive, from a user device, a ride hail request comprising a first biometric identifier associated with a rider;
cause to send a ride hail pickup communication to an autonomous vehicle, the ride hail pickup communication comprising the first biometric identifier, rider identification information, and destination information;
receive, from the autonomous vehicle, an identity verification result indicative that the first biometric identifier matches a second biometric identifier associated with the rider, the second biometric identifier obtained from the rider by the autonomous vehicle; and
cause to control of the autonomous vehicle to transport the rider to a destination based on the ride hail pickup communication and the identity verification result.

9. The system according to claim 8, wherein the processor is further programmed to:
receive, from the user device, an audio communication from the rider;
open a communication channel connecting the user device with the autonomous vehicle; and
provide the communication channel for communication between the rider and the user device.

10. The system according to claim 9, wherein the processor is further programmed to:
receive, from the user device, an instruction to provide one or more paid services for the rider.

11. The system according to claim 10, wherein the paid services comprise audio entertainment, video entertainment, and refreshment provisions to the rider; and transmitting the instruction to the autonomous vehicle.

12. The system according to claim 8, wherein the processor is further programmed to:
receive, from the autonomous vehicle, a real-time localization feed; and
cause to send the real-time localization feed to the user device.

13. The system according to claim 8, wherein the second biometric identifier is obtained via a vehicle-based object detection system.

14. The system according to claim 8, wherein the second biometric identifier is obtained via a vehicle-based voice recognition system.

15. A method for controlling an autonomous vehicle (AV), comprising:
receiving, via an AV controller, a ride hail pickup communication from a ride hail server, the ride hail pickup communication comprising a first biometric identifier associated with a rider, a rider pickup instruction, and rider destination information;
navigating to a pickup location based on the rider pickup instructions and on-boarding the rider associated with the ride hail pickup communication;
obtaining, via a biometric recognition module, a second biometric identifier associated with the rider;
identifying, via the biometric recognition module, an identity of the rider based on ride hail pickup communication and the second biometric identifier;
sending, via the AV controller, an identity verification result indicative that the first biometric identifier matches the second biometric identifier; and
causing control of the autonomous vehicle to transport the rider to a destination based on the ride hail pickup communication and the identity verification result.

16. The method according to claim 15, further comprising.
receiving, via a vehicle infotainment system, an audio communication to the rider;
opening a communication channel connecting a user device with an autonomous vehicle infotainment system; and
providing the communication channel for communication between the rider and the user device.

17. The method according to claim 16, further comprising:
receiving, from the ride hail server, an instruction to provide one or more paid services for the rider.

18. The method according to claim 17, wherein the paid services comprise audio entertainment, video entertainment, and refreshment provisions to the rider.

19. The method according to claim 15, further comprising:
sending, from the autonomous vehicle, a real-time localization feed, wherein the real-time localization feed provides a real-time location of the AV.

20. The method according to claim 15, wherein the second biometric identifier is obtained via an object detection system associated with the biometric recognition module.
